(19) United States
(12) Patent Application Publication
(10) Pub. No.: US 2022/0067528 A1
(43) Pub. Date: Mar. 3, 2022

(54) AGENT JOINING DEVICE, METHOD, AND PROGRAM

(71) Applicant: NIPPON TELEGRAPH AND TELEPHONE CORPORATION, Tokyo (JP)

(72) Inventors: Masahiro KOJIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/423,075

(22) PCT Filed: Jan. 7, 2020
(86) PCT No.: PCT/JP2020/000157

§ 371 Date: Jul. 14, 2021

(30) Foreign Application Priority Data
Jan. 16, 2019 (JP) 2019-005326

(51) Int. Cl. G06N 3/08; G06N 3/04

(52) U.S. Cl. CPC G06N 3/082; G06N 3/04

(57) ABSTRACT

It is possible to construct an agent that can deal with even a complicated task. For a value function for obtaining a policy for an action of an agent that solves an overall task represented by a weighting sum of a plurality of part tasks, an overall value function is obtained, which is a weighting sum of a plurality of part value functions learned in advance to obtain a policy for an action of a part agent that solves the part tasks for each of the plurality of part tasks using a weight for each of the plurality of part tasks. The action of the agent corresponding to the overall task is determined using a policy obtained from the overall value function and the agent is caused to act.

### TECHNICAL FIELD

The present invention relates to an agent coupling device, a method and a program, and more particularly, to an agent coupling device, a method and a program for solving a task.

### BACKGROUND ART

with the breakthrough of deep learning, AI (artificial intelligence) technologies are attracting great attention. Above all, deep reinforcement learning combined with a learning framework called “reinforcement learning” that does autonomous trial and error has achieved great results in the field of game AI (computer game, igo (board game of capturing territory) or the like (see Non-Patent Literature 1). In recent years, application of deep reinforcement learning to robot control, drone control and adaptive control of traffic signals (see Non-Patent Literature 2) or the like is being promoted.

### CITATION LIST

### Non-Patent Literature

Non-Patent Literature 1: Human-level control through deep reinforcement learning, Mnih, Volodymyr and Kavukcuoglu, Koray and Silver, David and Rusu, Andrei A. and Veness, Joel and Bellemare, Marc G and Graves, Alex and Riedmilier, Martin and Fidjel and, Andreas K and Ostrovski, Georg and others, Nature, 2015.

Non-Patent Literature 2: Using a deep reinforcement learning agent for traffic signal control, Genders, Wade and Razavi, Saiedeh, arXiv preprint arXiv: 1611.01142, 2016.

Non-Patent Literature 3: Reinforcement Learning with Deep Energy-Based Policies, Haarnoja, Tomas and Tang, Haoran and Abbeel, Pieter and Levine, Sergey, ICML, 2017.

Non-Patent Literature 4: Composable Deep Reinforcement Learning for Robotic Manipulation, Haarnoja, Tuomas and Pong, Vitchyr and Zhou, Aurick and Dalal, Murtaza and Abbeel, Pieter and Levine, Sergey, arXiv preprint arXiv: 1803.06773, 2018.

Non-Patent Literature 5: Distilling the knowledge in a neural network, Hinton, Geoffrey, and Vinyals, Oriol, and Dean, Jeff, arXiv preprint arXiv: 1503.02531 (2015).

### SUMMARY OF THE INVENTION

### Technical Problem

However, deep reinforcement learning has the following two weak points.

One is that deep reinforcement learning requires trial and error by an action subject (e.g., robot) called an “agent,” which generally takes a long learning time.

The other is that since a learning result of reinforcement learning depends on a given environment (task), if the environment changes, learning needs to be (basically) redone from zero.

Therefore, even if a task seems to be similar in the eyes of humans, the task needs to be relearned every time the environment changes, requiring a lot of efforts (manpower cost, calculation cost).

Bearing the aforementioned problem in mind, an approach is under study, in which a task to be a base and an agent to solve the task (called a “part task” and a “part agent” respectively) are learned in advance and an agent that solves a complicated overall task is created (constituted) by combining the part agent and the part task (see Non-Patent Literatures 3 and 4). However, since such an existing technique considers only a case where a task represented by a simple average is constructed using a simple average of the part agent, the number of applicable scenes is limited.

An object of the present invention, which has been made in view of the above circumstances, is to provide an agent coupling device, a method and a program capable of constructing an agent that can deal with even a complicated task.

### Means for Solving the Problem

In order to attain the above described object, an agent coupling device according to a first invention is configured by including an agent coupling unit that obtains an overall value function with respect to a value function for obtaining a policy for an action of an agent that solves an overall task represented by a weighting sum of a plurality of part tasks, the overall value function being a weighting sum of a plurality of part value functions learned in advance to obtain a policy for an action of a part agent that solves the part tasks for each of the plurality of part tasks using a weight for each of the plurality of part tasks and an execution unit that determines the action of the agent corresponding to the overall task using the policy obtained from the overall value function and causes the agent to act.

In the agent coupling device according to the first invention, the agent coupling unit may obtain, as a neural network that approximates the overall value function, a neural network constructed by adding a layer to be output with a weight assigned to each of the plurality of part tasks for a neural network learned in advance so as to approximate the part value function for each of the plurality of part tasks, and the execution unit may determine an action of an agent for the overall task using a policy obtained from the neural network that approximates the overall value function and cause the agent to act.

The agent coupling device according to the first invention may further include a relearning unit that relearns a neural network that approximates the overall value function based on an action result of the agent by the execution unit.

In the agent coupling device according to the first invention, the agent coupling unit may obtain, for each of the plurality of part tasks, a neural network constructed by adding a layer to be output with a weight assigned to each of the plurality of part tasks for a neural network learned in advance so as to approximate the part value function, as a neural network that approximates the overall value function and create a neural network having a predetermined structure corresponding to the neural network that approximates the overall value function, and the execution unit may determine the action of the agent for the overall task using the policy obtained from the neural network having the predetermined structure and cause the agent to act.

The agent coupling device according to the first invention may further include a relearning unit that relearns the neural network having the predetermined structure based on the action result of the agent by the execution unit.

An agent coupling method according to a second invention includes a step of obtaining an overall value function with respect to a value function for obtaining a policy for an action of an agent that solves an overall task represented by a weighting sum of a plurality of part tasks, the overall value function being a weighting sum of a plurality of part value functions learned in advance to obtain a policy for an action of a part agent that solves the part tasks for each of the plurality of part tasks using a weight for each of the plurality of part tasks and a step of an execution unit determining the action of the agent corresponding to the overall task using a policy obtained from the overall value function and causing the agent to act.

A program according to a third invention is a program for causing a computer to function as the respective components of the agent coupling device according to the first invention.

### Effects of the Invention

The agent coupling device, the method and the program of the present invention can achieve an effect of constructing an agent that can deal with even a complicated task.

### BRIEF DESCRIPTION OF DRAWINGS

FIG. 1 is a diagram illustrating a configuration example of a new network by DQN.

FIG. 2 is a block diagram illustrating a configuration of an agent coupling device according to an embodiment of the present invention.

FIG. 3 is a block diagram illustrating a configuration of an agent coupling unit.

FIG. 4 is a flowchart illustrating an agent processing routine in the agent coupling device according to the embodiment of the present invention.

### DESCRIPTION OF EMBODIMENTS

In view of the above problems, an embodiment of the present invention proposes a technique of constructing an overall task represented by a weighting sum using a weighting sum of a part agent. Examples of the overall task represented by a combination of weights include shooting games and signal control shown below. In a shooting game, it is assumed that a learning result A of solving a part task A of shooting down an enemy A and a learning result B of solving a part task B of shooting down an enemy B have already been obtained. At this time, for example, a task whereby 50 points are gained when the enemy A is shot down and 10 points are gained when the enemy B is shot down is expressed as a weighting sum of the part task A and the part task B. Similarly, it is assumed that a learning result A of solving a part task A whereby general vehicles are caused to pass with a short waiting time and a learning result B of solving a part task B whereby public vehicles such as buses are caused to pass with a short waiting time in signal control have already been obtained. At this time, for example, a task of minimizing [waiting time of general vehicle waiting time of public vehicle×5] is expressed by the above weighting sum of the part task A and the part task B. In the embodiment of the present invention, the learning result can be constructed also for the task represented by the above weighting sum, and a learning result of solving a complicated task can be obtained without relearning by only combining part agents for a new task or a learning result can be obtained in a shorter time than relearning from zero.

A technique of reinforcement learning, which is a premise, will be described before describing details of the embodiment of the present invention.

[Reinforcement Learning]

Reinforcement learning is a technique of finding an optimum policy with a setting defined as a Markov Decision Process (MDP) (Reference Literature 1).

[Reference Literature 1]

Reinforcement learning: An introduction, Richard S Sutton and Andrew G Barto, MIT press Cambridge, 1998.

Simply stated, the MDP describes interaction between an action subject (e.g., robot) and an outside world. The MDP is defined by five sets (S, A, P, R, γ): a set of states S={s₁, s₂, . . . , s_{S}} that a robot can take, a set of actions A={a₁, a₂, . . . , a_{A}} that the robot can take, a transition function P={p^{a}_{ss′}}_{s,s′,a} (where Σ_{s′}p^{a}_{ss′}=1) that defines the way of transition in state when the robot takes an action in a certain state, a reward function R={r₁, r₂, . . . , r_{S}} that gives information on how good an action taken by the robot in the certain state is, and a discount rate (where, 0≤γ1) that controls a degree of consideration for a reward to be received in the future.

In this setting of the MDP, the robot is given a degree of freedom regarding what action is to be executed in each state. A function for defining a probability that an action a will be executed when the robot is in each state s is called a “policy,” and is written as π. The policy π for the action a when the state s is given is expressed by (Σₐπ(a|s)=1). Reinforcement learning obtains an optimum policy π*_{std} which is a policy for maximizing an expected discount sum of rewards to be obtained from most currently until the future from among a plurality of policies.

$${π}_{std}^{*} = arg {max}_{π} {lim}_{T \to ∞} {E}^{π} [ {\sum }_{k = 0}^{T} {γ}^{k} ℛ ( {S}_{k} ) ]$$

It is a value function Q^{π} that plays an important role in deriving the optimum policy.

$${Q}^{π} ( s , a ) = {lim}_{T \to ∞} {E}^{π} [ {\sum }_{k = 0}^{T} {γ}^{k} ℛ ( {S}_{k} ) \vert {S}_{0} = s , {A}_{0} = a ]$$

The value function Q^{π} represents an expected discount sum of rewards obtained when the action a is executed in the state s and the action a continues to be executed to infinity according to the policy π after the execution. If the policy π is the optimum policy, a value function Q* (optimum value function) in the optimum policy is known to satisfy the following relationship and this expression is called a “Bellman optimum equation.”

$${Q}^{π} ( s , a ) = ℛ ( s ) + γ {\sum }_{{s}^{′}} {p}_{{ss}^{′}}^{a} {max}_{{a}^{′}} {Q}^{*} ( {s}^{′} , {a}^{′} )$$

Many techniques of reinforcement learning represented by Q learning estimates this optimum value function using the relationship in the above expression first, makes the following setting using the estimation result and thereby obtains the optimum policy π*.

$${π}_{std}^{*} ( a \vert s ) = δ ( a - arg {max}_{{a}^{′}} {Q}^{*} ( s , {a}^{′} ) )$$

Where δ(·) represents a delta function.

[Maximum Entropy Reinforcement Learning]

An approach called a “maximum entropy reinforcement learning” is proposed on the basis of the above standard reinforcement learning (Non-Patent Literature 3). This approach needs to be used to construct a new policy by coupling learning results.

Unlike the standard reinforcement learning, the maximum entropy reinforcement learning obtains an optimum policy π*ₘₑ that maximizes an expected discount sum of rewards obtained from most currently until the future and entropy of the policy.

$${π}_{me}^{*} = arg {max}_{π} {lim}_{T \to ∞} {E}^{π} [ {\sum }_{k = 0}^{T} {γ}^{k} \{ ℛ ( {S}_{k} ) + αℋ ( π ( \cdot \vert {S}_{k} ) ) \} ]$$

Where α represents entropy of a distribution {π(a₁|Sₖ), . . . , π(a_{A}|Sₖ)} that defines a selection probability of each action when a weight parameter, H(π(·|Sₖ)) is in a state Sₖ. Similarly to the previous section, an (optimum) value function Q*_{soft} can be defined as shown in following Expression (1) in the maximum entropy reinforcement learning.

$${Q}_{soft}^{*} ( s , a ) = {lim}_{T \to ∞} {E}^{π} [ {\sum }_{k = 0}^{T} {γ}^{k} \{ ℛ ( {S}_{k} ) + αℋ ( {π}_{me}^{*} ( \cdot \vert {S}_{k} ) ) \} \vert {S}_{0} = s , {A}_{0} = a ] \qquad ( 1 )$$

The optimum policy is given using this value function by following Expression (2).

$${π}_{me}^{*} = ( a \vert s ) exp ( \frac{1}{α} \{ {Q}_{soft}^{*} ( s , a ) - {V}_{soft}^{*} ( s ) \} ) . \qquad ( 2 )$$

Where, V*_{soft} is given as follows.

$${V}_{soft}^{*} ( s ) = αlog {\sum }_{{a}^{′}} exp ( \frac{1}{α} {Q}_{soft}^{*} ( s , {a}^{′} ) )$$

In this way, the optimum policy is expressed as a stochastic policy in maximum entropy reinforcement learning. Note that the value function can be estimated using the following Bellman equation in maximum entropy reinforcement learning as in the case of normal reinforcement learning.

$${Q}_{soft}^{*} ( s , a ) = ℛ ( s ) + γ {\sum }_{{s}^{′}} {p}_{{ss}^{′}}^{a} {V}_{soft}^{*} ( {s}^{′} )$$

[Configuration of Policy Using Simple Average (Existing Technique)]

First, a method of coupling learning results using the above existing technique will be described. In consideration of two MDPs differing only in reward functions: MDP-1 (S, A, P, R₁, γ) and MDP-2 (S, A, P, R₂, γ), Expression (1), which becomes as optimum value function of maximum entropy reinforcement learning is written as respective part value functions Q₁ and Q₂ regarding MDP-1 and MDP-2. Tasks for the respective MDPs have already been learned, and Q₁ and Q₂ are assumed to be known. Using these part value functions, consider constructing a policy of MDP-3 (S, A, P, R₃, γ), which is a target having reward R₃=(R₁+R₂)/2 defined by simple average.

According to the existing technique (Non-Patent Literature 4), the overall value function Q_{Σ} in the above setting is defined as follows.

Q_{Σ}½(Q₁+Q₂)

Assuming the overall value function Q_{Σ} as the optimum value function Q₃ of MDP-3, by substituting the optimum value function Q₃ in Expression (2), the coupled policy π_{Σ} is obtained. As a matter of course, since Q_{Σ} generally does not coincide with the optimum value function Q₃ of MDP-3, the policy π_{Σ} created using the above coupling method does not coincide with the optimum policy π*₃ of MDP-3. However, the presence of an expression that holds between the value function Q^{πΣ} and Q₃ when an action is performed according to π_{Σ} is proven (Non-Patent Literature 4), it is obvious that there is a relation between both values although it cannot be said to be a good approximation. Thus, the existing technique uses π_{Σ} as an initial policy when learning π_{Σ} using MDP-3, and thereby experimentally shows that learning can be achieved at a smaller count of learning than relearning from zero. In this way, the value function Q_{Σ} is used to obtain a policy for an action of an agent to solve an overall task represented by a weighting sum of a plurality of part tasks.

However, the existing technique only considers a case where a task represented by a simple average is constructed using a simple average of part agents, and the number of applicable scenes is limited.

### Principles according to Embodiment of Present Invention

Hereinafter, a method of constructing policies used in the embodiment of the present invention will be described.

[Configuration of Weighting Sum Policy]

As with the existing research, there are two MDPs differing only in reward functions: MDP-1: (S, A, P, R₁, γ) and MDP-2: (S, A, P, R₂, γ), the part value function of maximum entropy reinforcement learning in this MDP has already been learned, and Q₁ and Q₂ are assumed to be known.

With this setting, the embodiment of the, present invention considers constructing a policy of MDP-3: (S, A, P, R₃, γ) which is a target having reward R₃=β₁R₁+β₂R₂ defined by a weighting sum. β₁ and β₂ are known weight parameters.

The method proposed in the embodiment of the present invention is defined by following Expression (3).

Q_{Σ}=β₁Q₁+β₂Q₂ (3)

Assuming Q_{Σ} as an optimum value function Q₃ of MDP-3, Q_{Σ} is substituted in Expression (2) to obtain the coupled policy π_{Σ}. Q_{Σ} generally does not coincide with the optimum value function Q₃ of MDP-3, and the policy π_{Σ} created using the above coupling method does not coincide with the optimum policy π*₃ of the MDP-3. As described above, there is an expression that holds between the value function Q^{πΣ} and Q₃ when an action is performed according to π_{Σ}. Thus, it is assumed that π_{Σ} is used as a policy to solve the task corresponding to MDP-3. By using π_{Σ} as an initial policy when performing learning using MDP-3, learning can be achieved at a smaller count of learning than relearning from zero.

[When Performing Relearning]

As a specific example when performing relearning, a case will be shown where when a neural network (hereinafter also described as a “network”) that approximates the part value functions Q₁ and Q₂ has already performed learning using a Deep Q-Network (DQN) (Non-Patent Literature 2), these networks are combined to create an initial value of relearning.

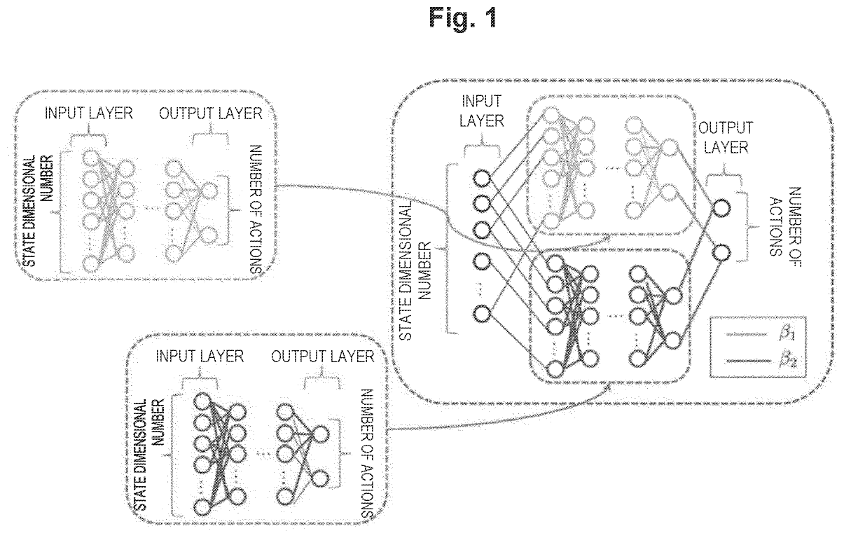

Mainly the following two methods can be considered. One is a method using simple coupling of the networks as they are. A news network is created in which a layer is added above art output layer of the network that returns the value of the learned Q₁ and the network that returns the value of Q₂ by assigning weights to their values as shown in Expression (3) and outputting the values. Relearning is performed by using this network as an initial value of the function that returns a value function. FIG. 1 illustrates a configuration example of the new network using DQN.

The other uses a technique called “distillation” (Non-Patent Literature 5). According to this technique, in a situation in which a network called a “Teacher Network” that produces a learning result is given, a Student Network using the number of network layers and an activation function or the like different from the Teacher Network is learned so as to have an input/output relationship similar to the Teacher Network. By creating the Student Network by using the network created by simple coupling as the first method as the Teacher Network, it is possible to create a network to be used as an initial value.

When the first approach is used, since the newly created network includes a number of parameters corresponding to the number of added parameters of the networks of Q₁ and Q₂, a problem may be produced in the case of a problem that the number of parameters is large. However, the new network can be simply created instead. On the contrary, the second approach needs to learn the Student Network, and so creating a new network may take much time, but it is possible to create a new network with fewer parameters.

Hereinafter, embodiments of the present invention will be described in detail with reference to the accompanying drawings.

### Configuration of Agent Coupling Device According to Embodiment of Present Invention

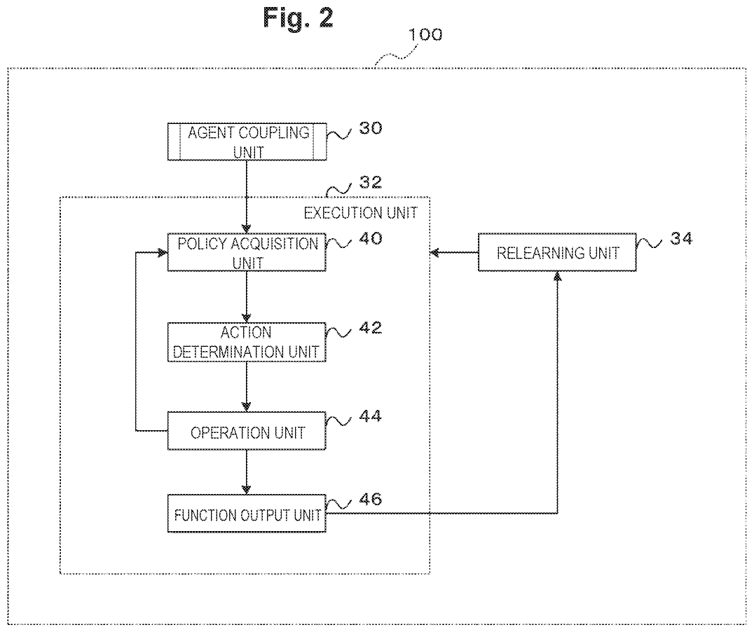

Next, a configuration of an agent coupling device according to an embodiment of the present invention will be described. As shown in FIG. 2, an agent coupling device 100 according to the embodiment of the present invention can be constructed of a computer including a CPU, a RAM and a ROM that stores a program to execute an agent processing routine, which will be described later, and various types of data. The agent coupling device 100 is functionally provided with an agent coupling unit 30, an execution unit 32 and a relearning unit 34 as shown in FIG. 2.

The execution unit 32 is configured by including a policy acquisition unit 40, an action determination unit 42, an operation unit 44 and a function output unit 46.

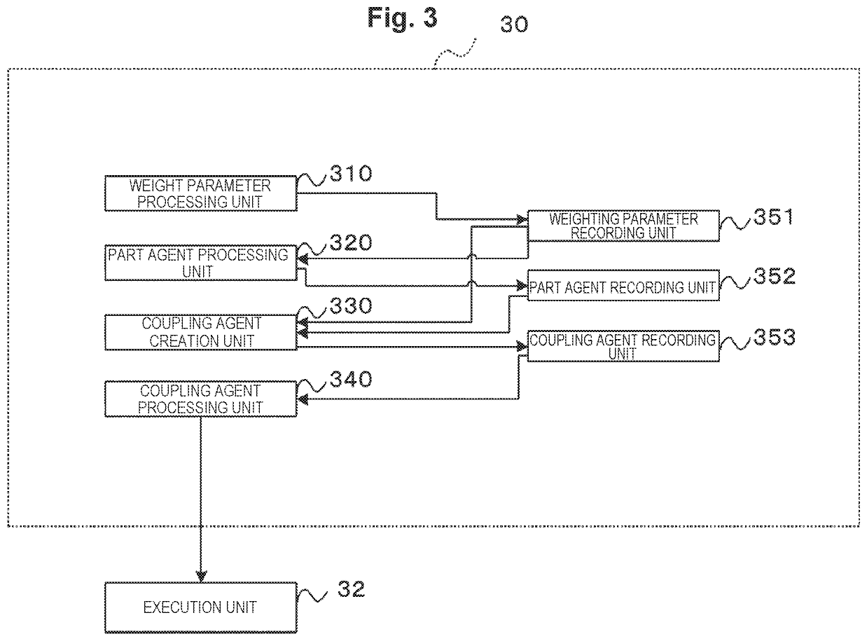

As shown in FIG. 3, the agent coupling unit 30 is configured by including a weight parameter processing unit 310, a part agent processing unit 320, a coupling agent creation unit 330, a coupling agent processing unit 340, a weight parameter recording unit 351, a part agent recording unit 352 and a coupling agent recording unit 353. In the embodiment of the present invention, it is assumed that part value functions Q₁ and Q₂ of part tasks and an overall value function Q_{Σ} are configured as a neural network learned in advance so as to approximate a value function using the above technique such as DQN. Note that a linear sum or the like may be used when it can be simply expressed.

Through the processes by the following respective processing units, the agent coupling unit 30 obtains, for each of a plurality of part tasks, a neural network constructed by adding a layer to be output with a weight assigned to each of the plurality of part tasks as a neural network that approximates an overall value function Q_{Σ} for a neural network learned in advance so as to approximate the part value functions (Q₁, Q₂).

The weight parameter processing unit 310 stores predetermined weight parameters β₁ and β₂ when coupling part tasks in the weight parameter recording unit 351.

The part agent processing unit 320 stores information relating to part value functions of part tasks (part value functions Q₁ and Q₂ themselves or network parameters that approximate them using DQN or the like) in the part agent recording unit 352.

The coupling agent creation unit 330 receives weight parameters β₁ and β₂ of the weight parameter recording unit 351, and Q₁ and Q₂ of the part agent recording unit 352 as input, and stores information relating to overall value function Q_{Σ}=β₁Q₁+β₂Q₂, which is the weighed coupling result (Q_{Σ} itself or neural network parameter that approximates Q_{Σ} or the like) in the coupling agent recording unit 353.

The coupling agent processing unit 340 outputs network parameters corresponding to the overall value function QΣ of the coupling agent recording unit 353 to the execution unit 32.

The execution unit 32 determines an action of an agent on the overall task using a policy obtained from a network corresponding to the overall value function Q_{Σ} through each processing unit, which will be described below, and causes the agent to act.

The policy acquisition unit 40 replaces Q*_{soft} in above Expression (2) with a network corresponding to the overall value function Q_{Σ} based on the network corresponding to the overall value function Q_{Σ} output from the agent coupling unit 30, and acquires a policy π_{Σ}.

The action determination unit 42 determines an of the agent corresponding to the overall task based on the policy acquired by the policy acquisition unit 40.

The operation unit 44 controls the agent so as to perform the determined action.

The function output unit 46 acquires a state Sₖ based on the action result of the agent and outputs the state Sₖ to the relearning unit 34. Note that after a certain number of actions, the function output unit 46 acquires an action result of the agent and the relearning unit 34 relearns a neural network that approximates the overall value function Q_{Σ}.

The relearning unit 34 relearns the neural network that approximates the overall value function Q_{Σ} so that the value of the reward function R₃=β₁R₁+β₂R₂ increases based on the state Sₖ based on the action result of the agent by the execution unit 32.

The execution unit 32 repeats the processes by the policy acquisition unit 40, the action determination unit 42 and the operation unit 44 using the neural network that approximates the relearned overall value function Q_{Σ} until a predetermined condition is satisfied.

### Operation of Agent Coupling Device According to Embodiment of Present Invention

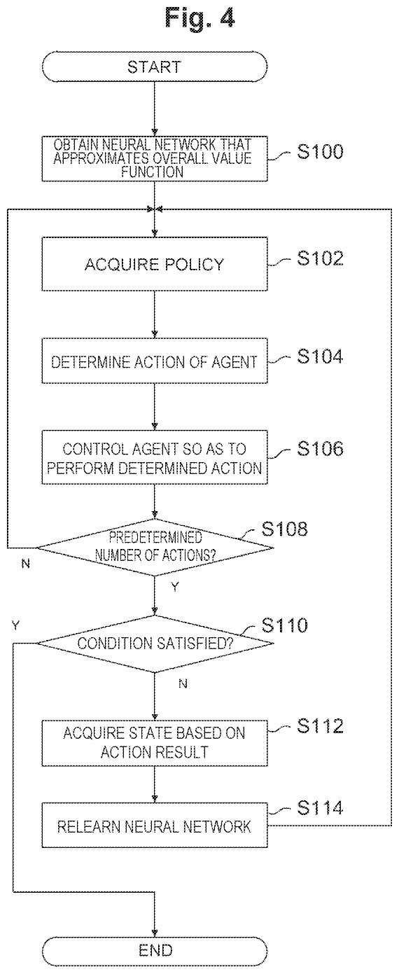

Next, operation of the agent coupling device 100 according to the embodiment of the present invention will be described. The agent coupling device 100 executes an agent processing routine shown in FIG. 4.

First, in step S100, the agent coupling unit 30 obtains, for each of a plurality of part tasks, a neural network constructed by adding a layer to be output with a weight assigned to each of the plurality of part tasks for a neural network learned in advance so as to approximate part value functions (Q₁, Q₂), as a neural network that approximates the overall value function Q_{Σ}.

Next, in step S102, the policy acquisition unit 40 replaces Q*_{soft} in above Expression (2) with a network that approximates the overall value function Q_{Σ} to acquire the policy π_{Σ}.

In step S104, the action determination unit 42 determines an action of an agent on the overall task based on the policy acquired by the policy acquisition unit 40.

In step S106, the operation unit 44 controls the agent so as to perform the determined action.

In step S108, the function output unit 46 determines whether a predetermined number of actions have been performed or not, proceeds to step S110 if a predetermined number of actions have been performed or returns to step S102 and repeats the process if a predetermined number of actions have not been performed.

In step S110, the function output unit 46 determines whether a predetermined condition has been satisfied or not, ends the process if a predetermined condition has been satisfied or proceeds to step S112 if a predetermined condition has not been satisfied.

In step S112, the function output unit 46 acquires a state Sₖ based on the action result of the agent and outputs the state Sₖ to the relearning unit 34.

in step S114, the relearning unit 34 relearns the neural network that approximates the overall value function Q_{Σ} so that the value of the reward function R₃=β₁R₁+β₂R₂ increases based on the state Sₖ based on the action result of the agent by the execution unit 32 and returns to step S102.

As described above, according to the agent coupling device according to the embodiment of the present invention, it is possible to deal with various tasks.

Note that the present invention is not limited to the aforementioned embodiments, but various modifications or applications can be made without departing from the spirit and scope of the invention.

For example, although a case has been described in the aforementioned embodiments where parameters of the neural network created by simply coupling neural networks that approximate part value functions Q₁ and Q₂ are learned in relearning, the present invention is not limited to this. When a distillation technique is used, the coupling agent processing unit 340 first simply couples neural networks that approximate the part value functions Q₁ and Q₂, creates a neural network that approximates an overall value function, learns parameters of the neural network having a predetermined structure so as to deal with the neural network that approximates the overall value function and designates the parameters as initial values of the parameters of the neural network having the predetermined structure. The execution unit 32 determines the action or the agent corresponding to the overall task using the policy obtained from the neural network having the predetermined structure and causes the agent to act. The relearning unit 34 relearns the parameters of the neural network having the predetermined structure based on the action result of the agent by the execution unit 32. Determination and execution of an action of the agent by the execution unit 32 and relearning by the relearning unit 34 may be repeated.

Without relearning by the relearning unit 34, the action of the agent may be controlled by only the agent coupling unit 30 and the execution unit 32. In this case, the coupling agent processing unit 340 may output the overall value function Q_{Σ} of the coupling agent recording unit 353 to the execution unit 32, the execution unit 32 may determine the action of the agent on the overall task using the policy obtained from the overall value function Q_{Σ} and cause the agent to act. More specifically, the policy acquisition unit 40 may replace Q*_{soft} in above Expression (2) with Q_{Σ} based on the overall value function Q_{Σ} output from the agent coupling unit 30 and acquire the policy π_{Σ}.

### REFERENCE SIGNS LIST

30 Agent coupling unit

32 Execution unit

34 Relearning unit

40 Policy acquisition unit

42 Action determination unit

44 Operation unit

46 Function output unit

100 Agent coupling device

310 Parameter processing unit

320 Part agent processing unit

330 Coupling agent creation unit

340 Coupling agent processing unit

351 Parameter recording unit

352 Part agent recording unit

353 Coupling agent recording unit

1. An agent coupling device comprising:
an agent coupling unit that obtains an overall value function with respect to a value function for obtaining a policy for an action of an agent that solves an overall task represented by a weighting sum of a plurality of part tasks, the overall value function being a weighting sum of a plurality of part value functions learned in advance to obtain a policy for an action of a part agent that solves the part tasks for each of the plurality of part tasks using a weight for each of the plurality of part tasks; and
an execution unit that determines the action of the agent corresponding to the overall task using the policy obtained from the overall value function and causes the agent to act.

2. The agent coupling device according to claim 1, wherein
the agent coupling unit obtains, as a neural network that approximates the overall value function, a neural network constructed by adding a layer to be output with a weight assigned to each of the plurality of part tasks for a neural network learned in advance so as to approximate the part value function for each of the plurality of part tasks, and
the execution unit determines an action of an agent for the overall task using a policy obtained from the neural network that approximates the overall value function and causes the agent to act.

3. The agent coupling device according to claim 2, further comprising a relearning unit that relearns a neural network that approximates the overall value function based on an action result of the agent by the execution unit.

4. The agent coupling device according to claim 1, wherein
the agent coupling unit obtains, for each of the plurality of part tasks, a neural network constructed by adding a layer to be output with a weight assigned to each of the plurality of part tasks for a neural network learned in advance so as to approximate the part value function, as a neural network that approximates the overall value function and creates a neural network having a predetermined structure corresponding to the neural network that approximates the overall value function, and
the execution unit determines the action of the agent for the overall task using a policy obtained from the neural network having the predetermined structure and causes the agent to act.

5. The agent coupling device according to claim 4, further comprising a relearning unit that relearns the neural network having the predetermined structure based on the action result of the agent by the execution unit.

6. An agent coupling method comprising:
a step of obtaining an overall value function with respect to a value function for obtaining a policy for an action of an agent that solves an overall task represented by a weighting sum of a plurality of part tasks, the overall value function being a weighting sum of a plurality of part value functions learned in advance to obtain a policy for an action of a part agent that solves the part tasks for each of the plurality of part tasks using a weight for each of the plurality of part tasks; and
a step of an execution unit determining the action of the agent corresponding to the overall task using a policy obtained from the overall value function and causing the agent to act.

7. A program for causing a computer to function as the respective components of the agent coupling device according to claim 1.
